(19) United States
(12) Patent Application Publication
(10) Pub. No.: US 2021/0080306 A1
(43) Pub. Date: Mar. 18, 2021

(54) BOX STRUCTURES RECOGNITION AND MEASUREMENT SYSTEM

(71) Applicant: CONARY ENTERPRISE CO., LTD., Taipei City (TW)

(72) Inventors: CHIEN-MING CHEN, TAIPEI CITY (TW); CHIA-WEI CHIEN, TAIPEI CITY (TW)

(21) Appl. No.: 16/568,483

(22) Filed: Sep. 12, 2019

(51) Int. Cl. G01F 17/00; G06T 7/62

(52) U.S. Cl. CPC G01F 17/00; G06Q 10/08345; G06T 7/62

(57) ABSTRACT

A box structure recognition and measurement system has a camera on a mobile device focusing on a box with a datum surface and then has the camera adjusting the angle of view for a laser module to project a laser point onto the box. On the screen of the mobile device, a window for measurement displays an image of the box with a baseline thereon. After the baseline is aligning with a horizontal position of the image manually, the image is retrieved and stored in a memory unit of the mobile device for a first microprocessor of the mobile device to perform measurements of the length, width and height of the box instantly and obtain further calculation results based on the measurements.

### BACKGROUND OF THE INVENTION

### 1. Field of the Invention

The present invention relates to a box structure recognition and measurement system, particularly to one that has a mobile device installed with a laser module and a measurement application program to instantly recognize a box structure in an image and further measure the length, width and height of the box structure.

### 2. Description of the Related Art

Online shopping has been one of the favorite choices for shoppers. When a product is ordered online, the merchandizer would put the ordered product into a box for shipment to the shoppers' house after the payment is made, and it has been a crucial issue of the length, width, height and volume of the boxes, in view of shipping costs and spaces for one shipment. However, even though online shopping has become such a common daily activity, there is still no such measurement system for quick and precise recognition and measurement of the box structures for the purpose of shipping costs calculation and for making use of the space for one shipment as much as possible.

### SUMMARY OF THE INVENTION

A primary objective of the present invention is to provide a box structure recognition and measurement system that is operated by a mobile device installed with a laser module and a measurement application program, in order to instantly recognize a box structure and learn the specific measurement data of the box.

To achieve the objects mentioned above, the present invention comprises a mobile device including a first microprocessor, a first screen electrically connected to said first microprocessor, a memory unit electrically connected to said first microprocessor, a camera electrically connected to said first microprocessor and a gyroscope electrically connected to said first microprocessor; a laser module coupled to said mobile device to be operated by said first microprocessor; and a measurement application program installed on said memory unit of the mobile device to be operated by said first microprocessor, upon being activated by said first microprocessor, said measurement application program having the laser module projecting a laser point, the gyroscope detecting a projection angle of said laser point, the camera of the mobile device being turned on and then the first screen displaying a window with a baseline for recognition and measurement, whereby a box with a datum surface is targeted in the window on the first screen of the mobile device and the camera of the mobile device is adjusted to focus on the box for the laser module to project a laser point onto the box; then the mobile device is manually moved to have the baseline in the window to be aligned with a horizontal position displayed in the window for retrieving an image with the box, said image being stored in the memory unit of the mobile device and then processed by the first microprocessor for calculation and measurement operation, a first edge line, a second edge line, a third edge line, a fourth edge line, a fifth edge line, a sixth edge line and a seventh edge line being recognized, then a first measurement point formed at an intersection point of said first and second edge lines, a second measurement point formed at an intersection point of said first and third edge lines, a third measurement point formed at an intersection point of said second, fourth and fifth edge lines, a fourth measurement point formed at an intersection point of said third, fourth and sixth edge lines, a fifth measurement point formed at an intersection point of said fifth and seventh edge lines and a sixth measurement point formed at an intersection point of said sixth and seventh edge lines being recognized as well, thereby completing the recognition and measurement process of the box.

In addition, the camera has an angle of view between 20°-75°.

The first, the fourth and the seventh edge lines are horizontal; the fourth edge line is longer than the first and the seventh edge lines. The third and the fifth edge lines have a negative slope and the second and sixth edge lines have a positive slope. The first and second edge lines further form a first angle larger than 90°. The first and the third edge lines further form a second angle larger than 90°. The second and the fourth edge lines further form a third angle less than 90°. The third and the fourth edge lines further form a fourth angle less than 90°. The fourth and the fifth edge lines further form a fifth angle less than 90°. The fourth and the sixth edge lines further form a sixth angle less than 90°. The fifth and the seventh edge lines further form a seventh angle larger than 90°.

And the sixth and the seventh edge lines further form an eighth angle larger than 90°.

Moreover, the first microprocessor is operated to have a distance between the first and the fourth edge lines measured and displayed on the first screen as a first measurement data, a length of the fourth edge line measured and displayed on the first screen as a second measurement data and a distance between the fourth and the seventh edge lines measured and displayed on the first screen as a third measurement data.

The first screen further includes a volume data displayed thereon; the volume data is a result calculated by the first, second and third measurement data.

The first screen further displays a measurement unit button, a file opening button, a box structure recognition button, a measurement operation button, a flashlight button and a laser display button in the window.

Furthermore, the mobile device is a smartphone, a tablet or a rangefinder, and the laser module is coupled to and disposed either inside or outside the mobile device.

A metallic piece is further attached on a back surface of a housing of the mobile device, and the laser module further has a magnet to be attached to the metallic piece for disposing the laser module onto the housing of the mobile device.

The mobile device further includes a first wireless transmitter disposed within the housing thereof, said first wireless transmitter being electrically connected to the first microprocessor, and the laser module further includes a carrier board, a second microprocessor disposed at a pre-determined position on the carrier board, a second wireless transmitter disposed at a pre-determined position on the carrier board, electrically connected to the second microprocessor and coupled to the first wireless processor of the mobile device, a driving circuit disposed at a pre-determined position on the carrier board and electrically connected to the second microprocessor, a light-emitting module disposed at a pre-determined position on the carrier board and electrically connected to the driving circuit, a light-receiving module disposed at a pre-determined position on the carrier board adjacent to the light-emitting module and electrically connected to the driving circuit, a case housing having the carrier board, the second microprocessor, the second wireless transmitter, the driving circuit, the light-emitting module and the light-receiving module disposed therein and an opening arranged at a side thereof, and a reflector unit disposed inside the case housing at a front of the light-emitting module and the light-receiving module and arranged sloped at an angle of 45° corresponding to the opening of the case housing.

With structures disclosed above, the present invention is able to recognize the box structure displayed on the window and further perform measurement of the length, width and height of the box structure, thereby getting further results such as the volume of the box or the total number of the periphery of the box.

### BRIEF DESCRIPTION OF THE DRAWINGS

FIG. 1 is a circuit block diagram illustrating a circuit connection of the present invention;

FIG. 2 is a schematic diagram illustrating a camera of a mobile device being adjusted for a laser module to project a laser point onto a box for measurement according to the present invention;

FIG. 3 is a schematic diagram illustrating the mobile device being moved for a baseline to be aligning with a horizontal position in an image displayed on the screen according to the present invention;

FIG. 4 is an application example illustrating an image being measured by the present invention;

FIG. 5 is a schematic diagram illustrating recognition of a box structure according to the present invention;

FIG. 6 is a schematic diagram illustrating a box being recognized and measured by the present invention;

FIG. 7 is a perspective view of the laser module and the mobile device before assembly in accordance with the present invention;

FIG. 8 is a perspective view of the laser module assembled with the mobile device according to the present invention; and

FIG. 9 is a schematic diagram illustrating an internal structure of the laser module according to the present invention.

### DETAILED DESCRIPTION OF THE PREFERRED EMBODIMENT

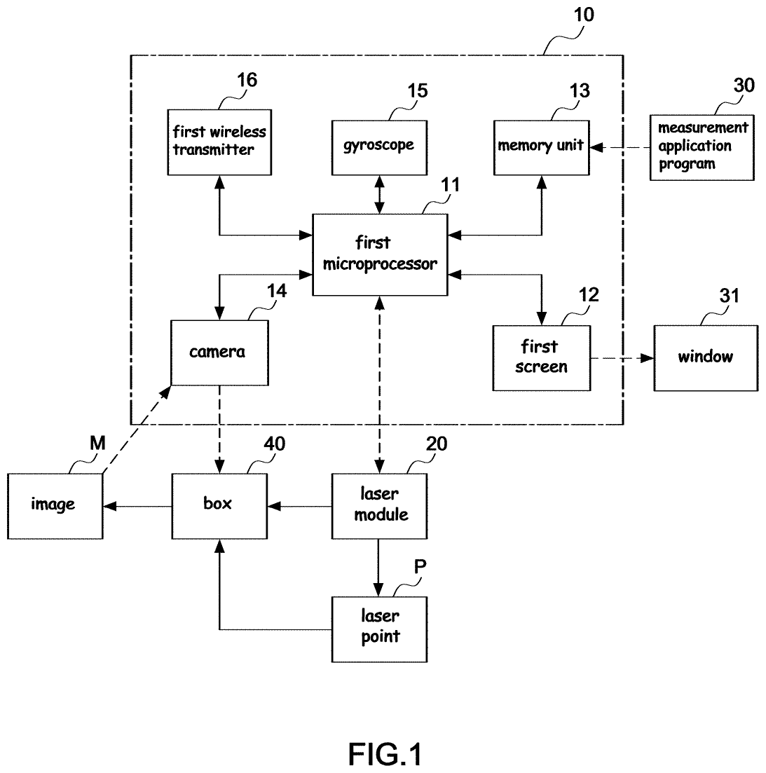

Referring to FIGS. 1-9, in a preferred embodiment of the present invention, a box structure recognition and measurement system 50 mainly includes a mobile device 10, a laser module 20 and a measurement application program 30.

The mobile device 10 includes a first microprocessor 11, a first screen 12 electrically connected to the first microprocessor 11, a memory unit 13 electrically connected to the first microprocessor 11, a camera 14 electrically connected to the first microprocessor 11 and a gyroscope 15 electrically connected to the first microprocessor 11. In this embodiment, the mobile device 10 is a smartphone, a tablet or a rangefinder.

The laser module 20 is coupled to the mobile device 10 to be operated by the first microprocessor 11. In this embodiment, the laser module 20 is coupled to and disposed either inside or outside the mobile device 10.

The measurement application program 30 is installed on the memory unit 13 of the mobile device 10 to be operated by the first microprocessor 11. Upon being activated by the first microprocessor 11, the measurement application program 30 has the laser module 20 projecting a laser point P; the camera 14 of the mobile device 10 is turned on and the gyroscope 15 is able to detect a projection angle of the laser point P. Then the first screen 12 of the mobile device 10 displays a window 31 with a baseline 311 for recognition and measurement.

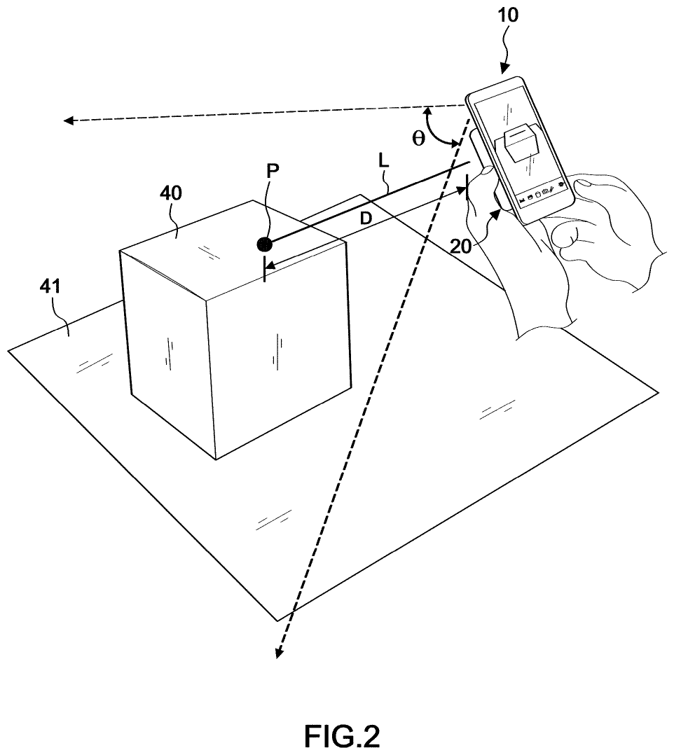

Further referring to FIG. 2, a box 40 with a datum surface 41 is targeted in the window 31 on the first screen 12 and the camera 14 is adjusted to focus on the box 40 for the laser module 20 to project a laser point P onto the box 40. In the embodiment, the camera 14 has an angle of view θ arranged between 20° to 75°.

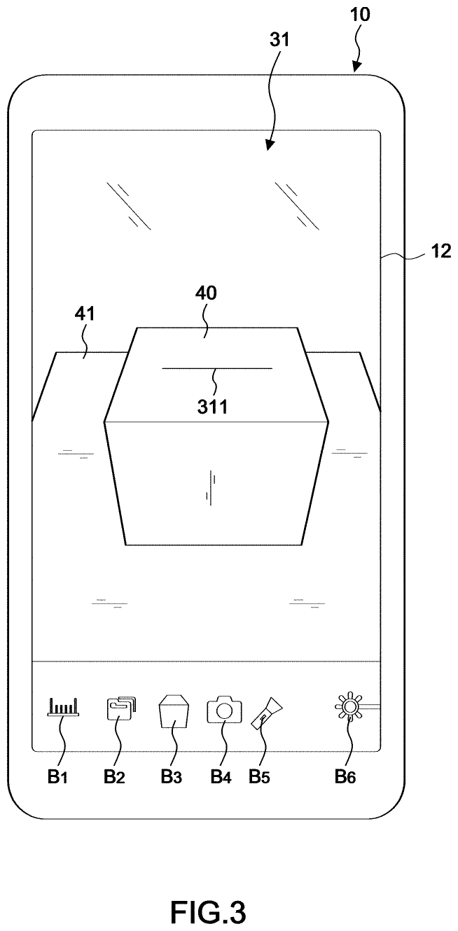

Then referring to FIG. 3, the mobile device 10 is manually moved to have the baseline 311 in the window 31 to be aligned with a horizontal position displayed in the window 31 for retrieving an image M with the box 40. In this embodiment, the first screen 12 further includes a measurement unit button B₁, a file opening button B₂, a box structure recognition button B₃, a measurement operation button B₄, a flashlight button B₅ and a laser display button B₆ in the window 31, but the present invention is not limited to such application.

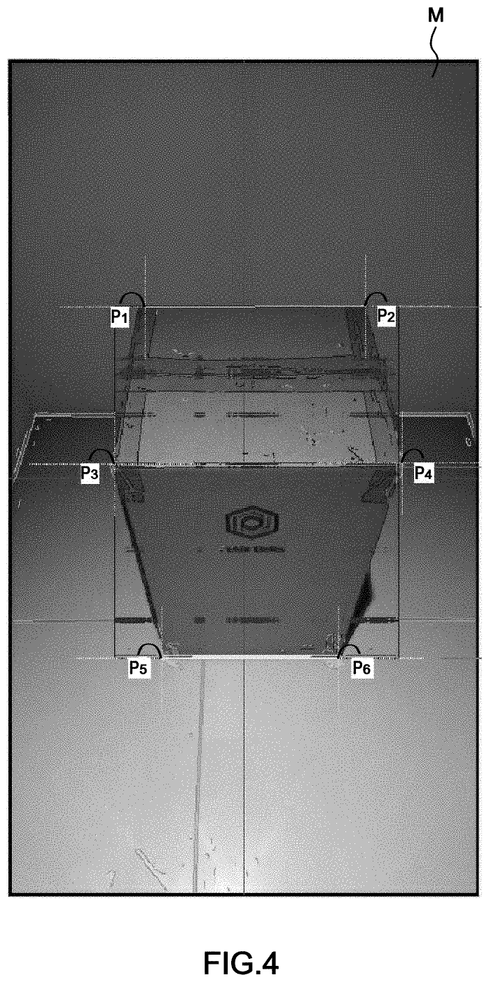

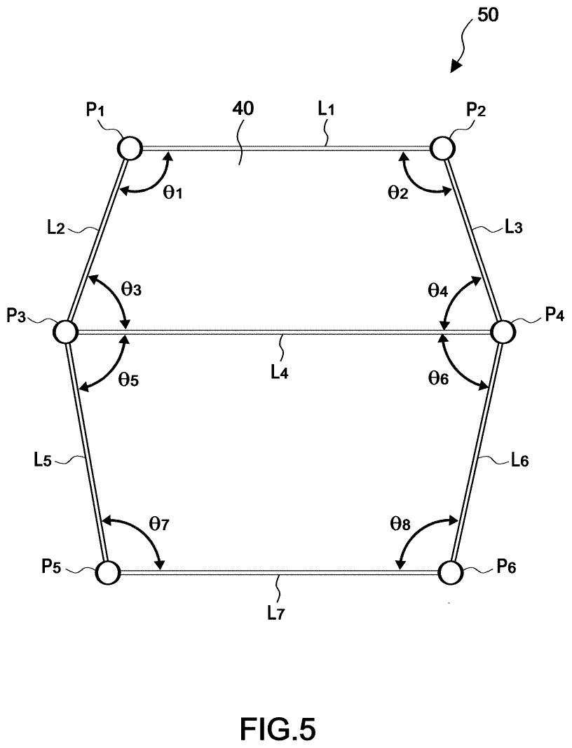

Referring to FIGS. 4 and 5, the image M is stored in the memory unit 13 of the mobile device 10 and is then processed by the first microprocessor 11 for calculation and measurement. A first edge line L₁, a second edge line L₂, a third edge line L₃, a fourth edge line L₄, a fifth edge line L₅, a sixth edge line L₆ and a seventh edge line L₇ are recognized. Then a first measurement point P₁ formed at an intersection point of the first and second edge lines L₁, L₂, a second measurement point P₂ formed at an intersection point of the first and third edge lines L₁, L₃, a third measurement point P₃ formed at an intersection point of the second, fourth and fifth edge lines L₂, L₄, L₅, a fourth measurement point P₄ formed at an intersection point of the third, fourth and sixth edge lines L₃, L₄, L₆, a fifth measurement point P₅ formed at an intersection point of the fifth and seventh edge lines L₅, L₇ and a sixth measurement point P₆ formed at an intersection point of the sixth and seventh edge lines L₆, L₇ are recognized as well, thereby completing the recognition and measurement process of the box 40.

Moreover, in the embodiment, the first, the fourth and the seventh edge lines L₁, L₄, L₇ are horizontal. The fourth edge line L₄ is longer than the first and the seventh edge lines L₁, L₇. The third and the fifth edge lines L₃, L₅ have a negative slope and the second and sixth edge lines L₂, L₆ have a positive slope. The first and second edge lines L₁, L₂ further form a first angle θ₁ larger than 90°. The first and the third edge lines L₁, L₃ further form a second angle θ₂ larger than 90°. The second and the fourth edge lines L₂, L₄ further form a third angle θ₃ less than 90°. The third and the fourth edge lines L₃, L₄ further form a fourth angle θ₄ less than 90°. The fourth and the fifth edge lines L₄, L₅ further form a fifth angle θ₅ less than 90°. The fourth and the sixth edge lines L₄, L₆ further form a sixth angle θ₆ less than 90°. The fifth and the seventh edge lines L₅, L₇ further form a seventh angle θ₇ larger than 90°. And the sixth and the seventh edge lines L₆, L₇ further form an eighth angle θ₈ larger than 90°.

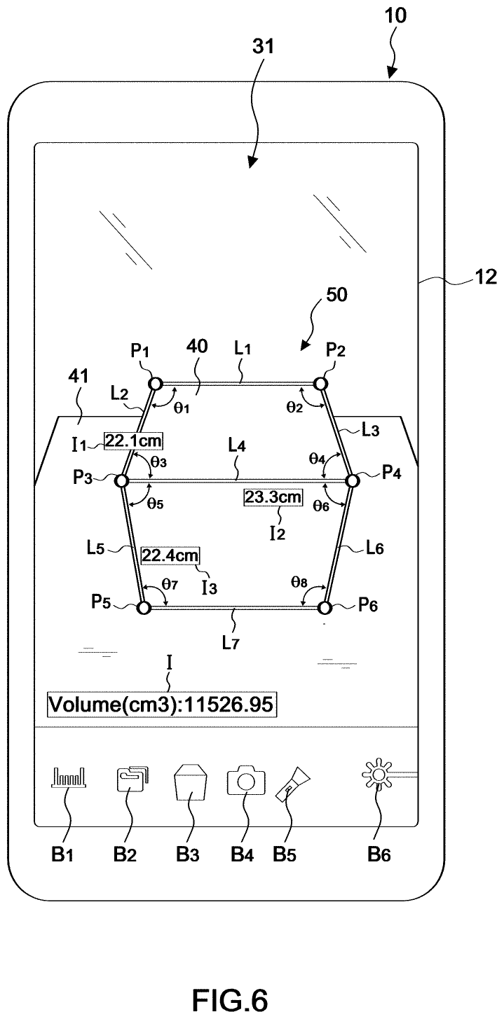

As illustrated in FIG. 6, the structure of the box 40 can be recognized and instantly by the present invention. Then the first microprocessor 11 is operated to have a distance between the first and the fourth edge lines L₁, L₄ measured and displayed on the first screen 12 as a first measurement data I₁, a length of the fourth edge line L₄ measured and displayed on the first screen 12 as a second measurement data I₂ and a distance between the fourth and the seventh edge lines L₄, L₇ measured and displayed on the first screen 12 as a third measurement data I₃. In this embodiment, the first screen 12 further includes a volume data I displayed thereon which is the result calculated by the first, second and third measurement data I₁, I₂, I₃. But the present invention is not limited to such application.

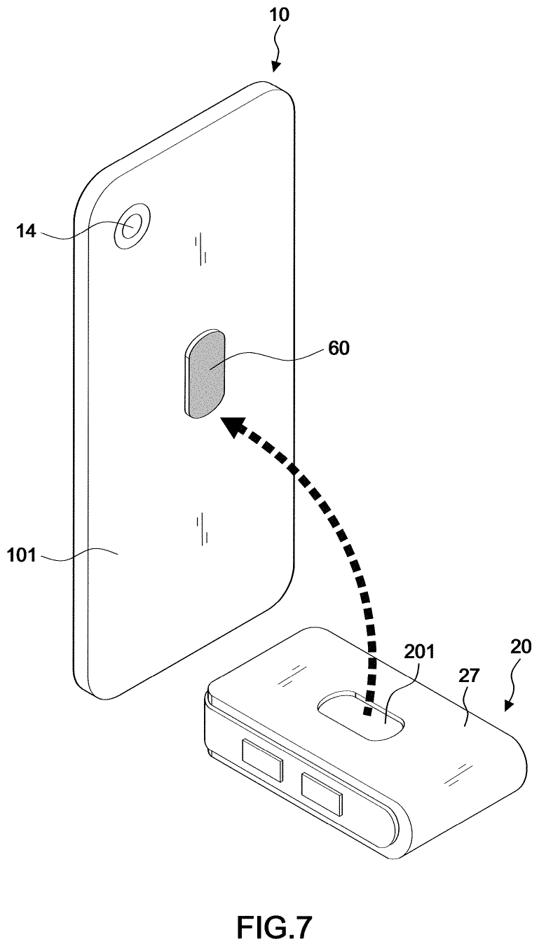

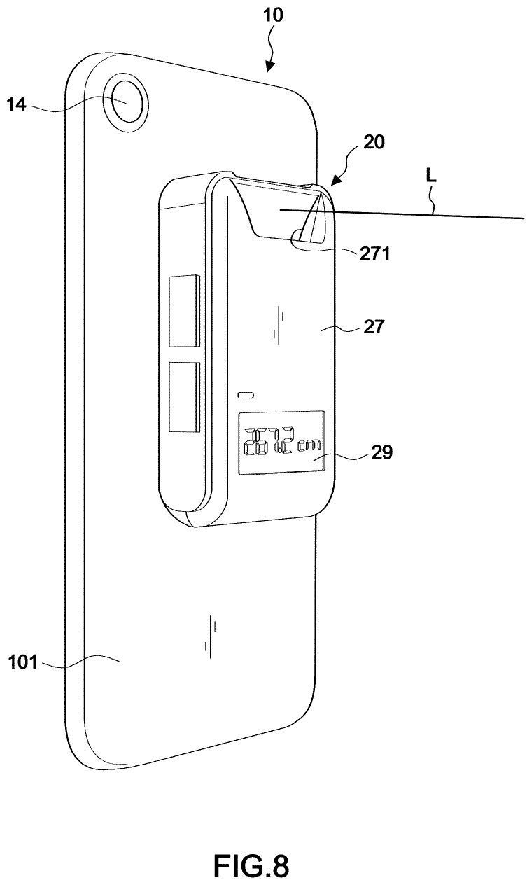

Referring to FIGS. 7 and 8, a metallic piece 60 is further attached on a back surface of a housing 101 of the mobile device 10, and the laser module 20 further has a magnet 201 to be attached to the metallic piece 60 for disposing the laser module 20 onto the housing 101 of the mobile device 10, but the present invention is not limited to such application.

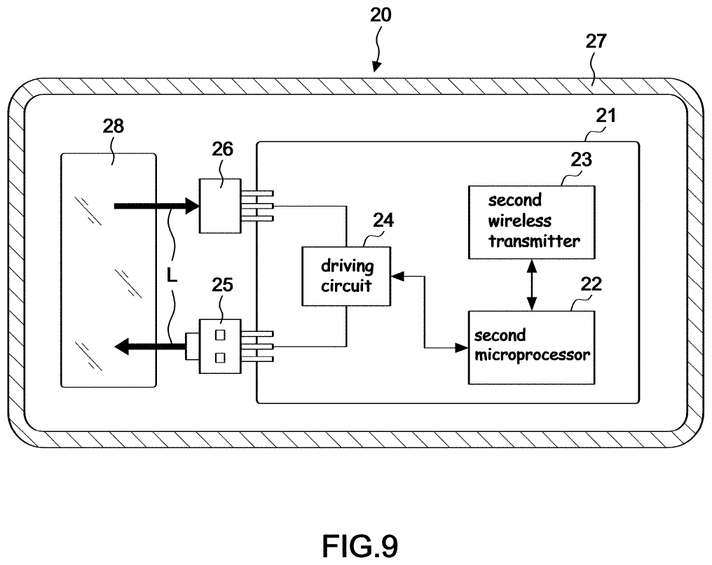

Referring back to FIG. 1, the mobile device 10 further includes a first wireless transmitter 16 disposed within the housing 101. The first wireless transmitter 16 is electrically connected to the first microprocessor 11. With reference to FIG. 9, the laser module 20 further includes a carrier board 21 and a second microprocessor 22, a second wireless transmitter 23, a driving circuit 24, a light-emitting module 25 and a light-receiving module 26 disposed individually at each pre-determined position on the carrier board 21.

The second wireless transmitter 23 is electrically connected to the second microprocessor 22 and coupled to the first wireless processor 16 of the mobile device 10. The driving circuit 24 is electrically connected to the second microprocessor 22. The light-emitting module 25 is electrically connected to the driving circuit 24. The light-receiving module 26 is adjacent to the light-emitting module 25 and is electrically connected to the driving circuit 24. A case housing 27 is further arranged to have the carrier board 21, the second microprocessor 22, the second wireless transmitter 23, the driving circuit 24, the light-emitting module 25 and the light-receiving module 26 disposed therein, and the case housing 27 further includes an opening 271 arranged at a side thereof. A reflector unit 28 is also disposed inside the case housing 27 at the front of the light-emitting module 25 and the light-receiving module 26 and is arranged sloped at an angle of 45° corresponding to the opening 271 of the case housing 27.

Thereby when the light-emitting module 25 emits a laser beam L, the laser beam L is reflected by the reflector unit 28 to be emitted out from the opening 271 of the case housing 27 to the box 40; then the box 40 further reflects the laser beam L back to the light-receiving module 26 so that the second microprocessor 22 is able to perform calculation of a distance D between the laser module 20 and the box 40. The case housing 27 further has a second screen 29 thereon, electrically connected to the second microprocessor 22 for displaying the result of the distance D calculated thereon. But the present invention is not limited to such application.

With the structures disclosed above, the present invention has the mobile device 10, the laser module 20 and the measurement application program 30 to form the box structure recognition and measurement system 50. The system can instantly recognize a box structure in an image and further obtain the measurement results of the length, width and height of the box structure; even further calculation results of the measured numbers are accessible simply by operation of the system. Such function is exactly the solution for the merchandizers to the problem of imprecise and improper estimation of the volume of the boxes and the spaces for stacking the boxes for shipment without spending too much time in the calculation process.

Although particular embodiment of the invention has been described in detail for purposes of illustration, various modifications and enhancements may be made without departing from the spirit and scope of the invention. Accordingly, the invention is not to be limited except as by the appended claims.

What is claimed is:

1. A box structure recognition and measurement system, comprising:
a mobile device including a first microprocessor, a first screen electrically connected to said first microprocessor, a memory unit electrically connected to said first microprocessor, a camera electrically connected to said first microprocessor and a gyroscope electrically connected to said first microprocessor;
a laser module coupled to said mobile device to be operated by said first microprocessor; and
a measurement application program installed on said memory unit of the mobile device to be operated by said first microprocessor, upon being activated by said first microprocessor, said measurement application program having the laser module projecting a laser point, the gyroscope detecting a projection angle of said laser point, the camera of the mobile device being turned on and then the first screen displaying a window with a baseline for recognition and measurement, whereby a box with a datum surface is targeted in the window on the first screen of the mobile device and the camera of the mobile device is adjusted to focus on the box for the laser module to project a laser point onto the box; then the mobile device is manually moved to have the baseline in the window to be aligned with a horizontal position displayed in the window for retrieving an image with the box, said image being stored in the memory unit of the mobile device and then processed by the first microprocessor for calculation and measurement operation, a first edge line, a second edge line, a third edge line, a fourth edge line, a fifth edge line, a sixth edge line and a seventh edge line being recognized, then a first measurement point formed at an intersection point of said first and second edge lines, a second measurement point formed at an intersection point of said first and third edge lines, a third measurement point formed at an intersection point of said second, fourth and fifth edge lines, a fourth measurement point formed at an intersection point of said third, fourth and sixth edge lines, a fifth measurement point formed at an intersection point of said fifth and seventh edge lines and a sixth measurement point formed at an intersection point of said sixth and seventh edge lines being recognized as well, thereby completing the recognition and measurement process of the box.

2. The box structure recognition and measurement system as claimed in claim 1, wherein an angle of view of the camera is arranged at 20°-75°.

3. The box structure recognition and measurement system as claimed in claim 1, wherein the first, the fourth and the seventh edge lines are horizontal, the fourth edge line being longer than the first and the seventh edge lines, the third and the fifth edge lines have a negative slope and the second and sixth edge lines have a positive slope, the first and second edge lines forming a first angle larger than 90°, the first and the third edge lines forming a second angle larger than 90°, the second and the fourth edge lines forming a third angle less than 90°, the third and the fourth edge lines forming a fourth angle less than 90°, the fourth and the fifth edge lines forming a fifth angle less than 90°, the fourth and the sixth edge lines forming a sixth angle less than 90°, the fifth and the seventh edge lines forming a seventh angle larger than 90°, and the sixth and the seventh edge lines forming an eighth angle larger than 90°.

4. The box structure recognition and measurement system as claimed in claim 1, wherein the first microprocessor is operated to have a distance between the first and the fourth edge lines measured and displayed on the first screen as a first measurement data, a length of the fourth edge line measured and displayed on the first screen as a second measurement data and a distance between the fourth and the seventh edge lines measured and displayed on the first screen as a third measurement data.

5. The box structure recognition and measurement system as claimed in claim 4, wherein the first screen further includes a volume data displayed thereon, said volume data being a result calculated by the first, second and third measurement data.

6. The box structure recognition and measurement system as claimed in claim 1, wherein the first screen further displays a measurement unit button, a file opening button, a box structure recognition button, a measurement operation button, a flashlight button and a laser display button in the window.

7. The box structure recognition and measurement system as claimed in claim 1, wherein the mobile device is a smartphone, a tablet or a rangefinder.

8. The box structure recognition and measurement system as claimed in claim 1, wherein the laser module is coupled to and disposed either inside or outside the mobile device.

9. The box structure recognition and measurement system as claimed in claim 1, wherein a metallic piece is further attached on a back surface of a housing of the mobile device, and the laser module further has a magnet to be attached to the metallic piece for disposing the laser module onto the housing of the mobile device.

10. The box structure recognition and measurement system as claimed in claim 1, wherein the mobile device further includes a first wireless transmitter disposed within the housing thereof, said first wireless transmitter being electrically connected to the first microprocessor, and the laser module further includes a carrier board, a second microprocessor disposed at a pre-determined position on the carrier board, a second wireless transmitter disposed at a pre-determined position on the carrier board, electrically connected to the second microprocessor and coupled to the first wireless processor of the mobile device, a driving circuit disposed at a pre-determined position on the carrier board and electrically connected to the second microprocessor, a light-emitting module disposed at a pre-determined position on the carrier board and electrically connected to the driving circuit, a light-receiving module disposed at a pre-determined position on the carrier board adjacent to the light-emitting module and electrically connected to the driving circuit, a case housing having the carrier board, the second microprocessor, the second wireless transmitter, the driving circuit, the light-emitting module and the light-receiving module disposed therein and an opening arranged at a side thereof, and a reflector unit disposed inside the case housing at a front of the light-emitting module and the light-receiving module and arranged sloped at an angle of 45° corresponding to the opening of the case housing.
